(19) United States
(12) Patent Application Publication
(10) Pub. No.: US 2012/0299798 A1
(43) Pub. Date: Nov. 29, 2012

(54) Dielectrically Loaded Antenna

(75) Inventor: Oliver Paul Leisten, Northampton (GB)

(73) Assignee: SARANTEL LIMITED, Wellingborough (GB)

(21) Appl. No.: 13/477,607

(22) Filed: May 22, 2012

Related U.S. Application Data
(60) Provisional application No. 61/496,226, filed on Jun. 13, 2011.

(30) Foreign Application Priority Data
May 26, 2011 (GB) 1109000.8

(51) Int. Cl. H01Q 1/36

(52) U.S. Cl. 343/895

(57) ABSTRACT

A dielectrically loaded antenna for operation at first and second frequencies above 200 MHz with circularly polarized radiation includes an electrically insulative dielectric core of solid material having a relative dielectric constant greater than 5, and a three-dimensional antenna element structure linked to a pair of feed coupling nodes. The antenna element structure is divided into a distal section and a proximal section respectively having a first set of elongate conductors on or adjacent a distal part of the core side surface portion and a second set of elongate conductors on or adjacent a proximal part of the core side surface portion, and wherein the first set of conductors is resonant at the first operating frequency and the second set of conductors is resonant at the second operating frequency.

### CROSS REFERENCE TO RELATED APPLICATIONS

This application claims the benefit of the filing date of U.S. Provisional Patent Application No. 61/496,226 filed on Jun. 13, 2011, the entire disclosure of which is hereby incorporated herein by reference.

### BACKGROUND OF THE INVENTION

The present application relates to a dielectrically loaded antenna for operation at frequencies in excess of 200 MHz, and primarily but not exclusively to a multifilar helical antenna for operation with circularly polarized electromagnetic radiation.

Dielectrically loaded quadrifilar helical antennas are disclosed in British Patent Applications Nos. 2292638A, 2310543A, and 2367429A and International Application No. WO2006/136809. Such antennas are intended mainly for receiving circularly polarized signals from a global navigation satellite system (GNSS), e.g. from the satellites of the Global Positioning System (GPS) satellite constellation, for position fixing and navigation purposes. GPS in the L1 band and the corresponding Galileo service are narrowband services. There are other satellite-based services requiring receiving or transmitting apparatus of greater fractional bandwidth than that available from the prior antennas. One antenna offering increased bandwidth is that disclosed in British Patent Application No. 2424521A.

Related antennas are disclosed in British Patent Application No. 2445478A. This application discloses hexafilar and octafilar antennas offering greater bandwidth and/or higher gain than a comparable quadrifilar antenna. British Patent Application No. 2468582 discloses a dual-band antenna having ten co-extensive helical elements. Some of the elements are longer than the others so as to define two circular-polarization resonances for, e.g., coverage of uplink and downlink bands of the TerreStar (Registered Trade Mark) S-band satellite telephone service.

### BRIEF SUMMARY OF THE INVENTION

It is an object of the present invention to provide a versatile antenna with plural circular polarization resonances.

According to embodiments of the invention, a dielectrically loaded antenna for operation at first and second frequencies above 200 MHz and with circularly polarized radiation comprises: an electrically insulative dielectric core of a solid material which has a relative dielectric constant greater than 5, the core having an outer surface with a side surface portion and proximal and distal end surface portions, and the material of the core occupying the major part of the interior volume defined by the core outer surface; a pair of feed coupling nodes; and a three-dimensional antenna element structure linked to the feed coupling nodes and including a plurality of elongate conductive antenna elements distributed around the core on or adjacent the said side surface portion; wherein the antenna element structure is divided into a distal section and a proximal section respectively comprising a first set of elongate conductors on or adjacent a distal part of the core side surface portion and a second set of elongate conductors on or adjacent a proximal part of the core side surface portion, and wherein the first set of conductors is resonant at the first operating frequency and the second set of conductors is resonant at the second operating frequency. Preferably the antenna element structure further comprises an intermediate conductive ring encircling the core. This ring may be located between the first and second set of elongate conductors, one of these sets of conductors linking the feed coupling nodes and the intermediate ring, the other set extending from the intermediate ring on the opposite side from the feed coupling nodes to open-circuit or closed-circuit ends.

A single-pole or dual-pole matching network is preferably provided between the feed coupling nodes and the said one said of elongate conductors. Typically, the individual elongate conductors of each set are connected individually to the intermediate ring.

The preferred antenna is a backfire antenna, with the feed coupling nodes located on the distal end surface portion of the core. It is preferred that the set of elongate conductors extending from the intermediate conductive ring away from the feed coupling nodes are terminated on an annular edge of a second conductive ring located on the end surface portion of the core opposite from that associated with the feed coupling nodes.

In the case of a backfire antenna having a feed structure with a transmission line extending through the core, the second conductive ring is formed by a conductive sleeve connected to the transmission line section at the proximal end surface portion of the core thereby to form a sleeve balun converting unbalanced currents at the proximal end surface portion to balanced currents at the distal end surface portion.

Advantageously, the intermediate conductive ring defines an annular conductive path having an electrical length equal to one wavelength at the resonant frequency of the set of elongate conductors connected to the feed coupling nodes. The second conductive ring, similarly, defines a conductive path having an electrical length equal to one wavelength at the resonant frequency of the other set of elongate conductors.

In this way, the antenna defines at least two resonant modes associated with circular polarization. A first resonant mode arises from currents travelling along the conductors of the first which are phased by currents circulating on the associated edge of the intermediate ring. A second resonant mode is defined by currents excited in the second set of elongate conductors, phasing of which currents is driven by currents circulating on the annular edge of the second conductive ring. Each resonant mode occurs at a different frequency, defined by the length of the elements in the respective sets and by the electrical lengths of the respective annular conductive paths. Typically, the electrical length of the annular conductive path provided by the intermediate ring is less than that provided by the second conductive ring, yielding a higher resonant frequency for the elements linking the feed coupling nodes and the intermediate ring than that associated with the elements between the intermediate ring and the second conductive ring.

In the preferred antenna, the core has a substantially constant cross-section between the proximal and distal end portions, and is advantageously cylindrical, the elongate conductors of the first set and those of the second set being helical, e.g. formed as printed tracks on the cylindrical side surface portion of the core.

The antenna described herein offers better performance that that disclosed in GB 2468582A when the frequency spacing of the operating frequencies is greater than 3 percent of the mean of operating frequencies. It is also preferred that the frequency spacing is less than 50 percent of the mean of the first and second operating frequencies. The described antenna is particularly useful when the required frequency spacing is greater than 5 percent of the mean or less than 15 percent.

Although, in the preferred embodiment, the intermediate conductive ring and the second conductive ring are continuous conductors, it is possible, within the scope of the invention, for either or both of them to be formed by a combination of conductive elements and capacitances, providing the capacitances are of a value such that a complete conductive loop is provided at the relevant operating frequency or frequencies.

### BRIEF DESCRIPTION OF THE DRAWINGS

The invention will now be described by way of example with reference to the drawings in which:

FIG. 1 is a perspective view of an antenna in accordance with the invention

FIG. 2 is an axial cross-section of a feed structure of the antenna of FIG. 1;

FIGS. 3A and 3B are side views of the antenna of FIG. 1, FIG. 3A being a true side elevation, and FIG. 3B being a modified side elevation with the material of the antenna core removed to render visible an axial feed line and helical antenna elements on the rear surface of the antenna, both normally hidden by the material of the core when viewed from the side;

FIG. 4 is a detail of the feed structure shown in FIG. 2, showing a laminate board thereof detached from a distal end portion of a feeder transmission line;

FIGS. 5A, 5B and 5C are diagrams showing conductor patterns of three conductive layers of the laminate board of the feeder structure; and

FIG. 6 is an equivalent circuit diagram;

FIG. 7 is a graph illustrating the insertion loss (S₁₁) frequency response of the antenna of FIG. 1;

FIG. 8 is a detail of an alternative feed structure;

FIGS. 9A and 9B are diagrams showing conductor patterns of two conductive layers of the laminate board of the alternative feed structure shown in FIG. 8; and

FIG. 10 is another equivalent circuit diagram.

### DETAILED DESCRIPTION OF THE DRAWINGS

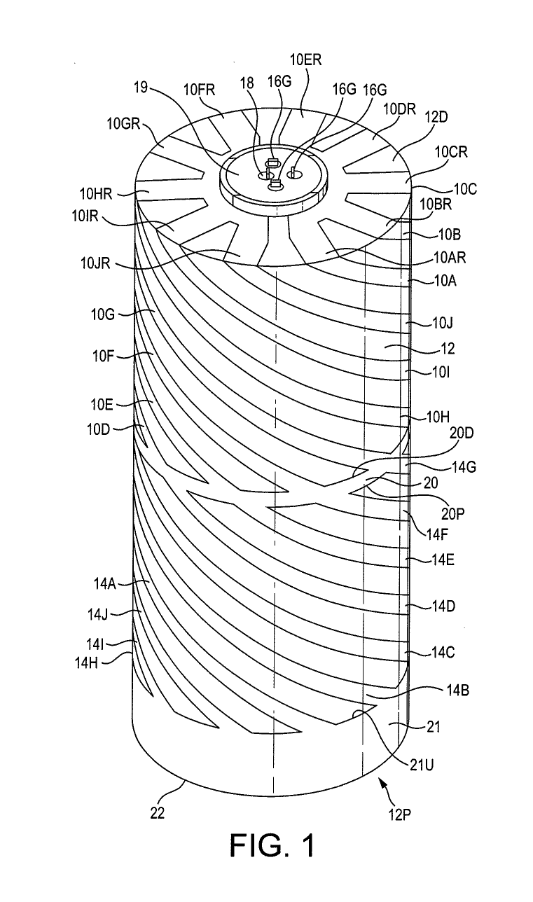

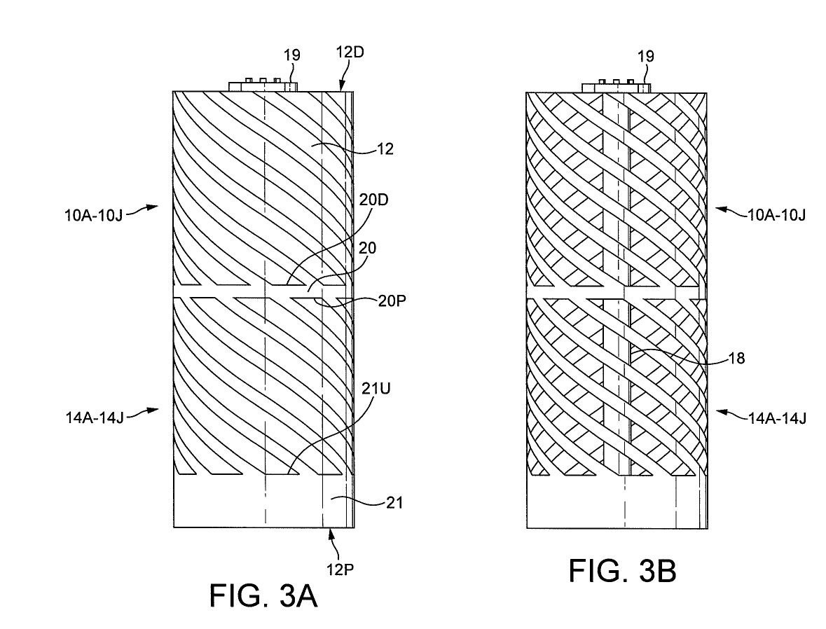

Referring to FIGS. 1, 2, 3A and 3B, a dual-band multifilar helical antenna in accordance with the invention has an antenna element structure having a first set of ten elongate antenna elements in the form of ten axially co-extensive helical conductive tracks 10A, 10B, 10C, 10D, 10E, 10F, 10G, 10H, 10I, 10J plated or otherwise metallized on a distal part of the cylindrical outer side surface portion of a cylindrical core 12. These antenna elements 10A-10J are each half-turn helical elements of substantially equal length and co-extensive in the axial direction of the core. On a proximal part of the cylindrical outer side surface portion of the core 12, the antenna element structure has a second set of ten elongate antenna elements. These elements are also in the form of ten axially coextensive helical conductive tracks numbered 14A, 14B, 14C, 14D, 14E, 14F, 14G, 14H, 14I, 14J in FIGS. 1, 3A and 3B, and are likewise plated or otherwise metallised on the side surface portion of the core.

The core is made of a ceramic material. In this case it is a calcium-magnesium titanate material having a relative dielectric constant in the region of 26. This material is noted for its dimensional and electrical stability with varying temperature, and low dielectric loss. In this embodiment, which is intended for operation at about 1550 MHz and 1650 MHz, the core has a diameter of 14 mm. The length of the core, at 33 mm, is greater than the diameter but, in other embodiments of the invention, it may be less. The core is produced by pressing, but may be produced in an extrusion process, the core then being fired.

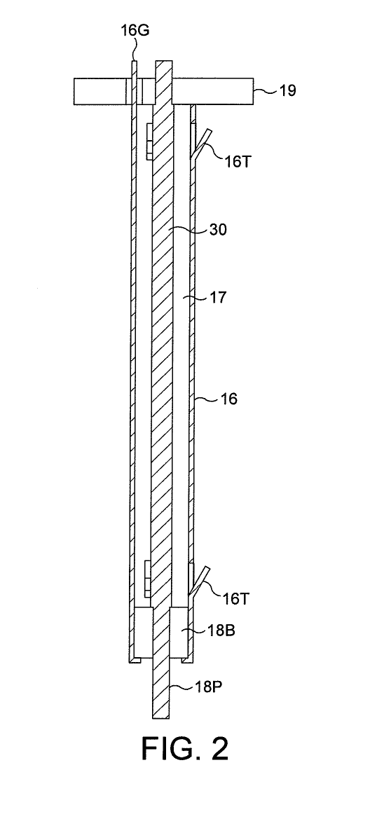

This preferred antenna is a backfire helical antenna in that it has a coaxial transmission line section housed in an axial bore that passes through the core from a distal end face 12D to a proximal end face 12P of the core. Both end faces 12D, 12P are planar and perpendicular to the central axis of the core. They are oppositely directed, in that one is directed distally and the other proximally in this embodiment of the invention. The coaxial transmission line is a rigid coaxial feeder which is housed centrally in the bore with the outer shield conductor spaced from the wall of the bore so that there is, effectively, a dielectric layer (in this case an air sleeve) between the shield conductor and the material of the core 12. Referring to FIG. 2, the coaxial transmission line feeder has a conductive tubular outer shield 16, a first tubular air gap or insulating layer 17, and an elongate inner conductor 18 which is insulated from the shield by the insulating layer 17. The shield 16 has outwardly projecting and integrally formed spring tangs 16T or spacers which space the shield from the walls of the bore. A second tubular air gap exists between the shield 16 and the wall of the bore. The insulative layer 17 may, instead, be formed as a plastics sleeve, as may the layer between the shield 16 and the walls of the bore. At the lower, proximal end of the feeder, the inner conductor 18 is centrally located within the shield 16 by an insulative bush (not shown), as described in our above-mentioned WO2006/136809.

The combination of the shield 16, inner conductor 18 and insulative layer 17 constitutes a transmission line of predetermined characteristic impedance, here 50 ohms, passing through the antenna core 12 for coupling distal ends of the antenna elements 10A-10J of the first set to radio frequency (RF) circuitry of equipment to which the antenna is to be connected. The couplings between the antenna elements 10A-10J and the feeder are made via conductive connection portions associated with the helical tracks 10A-10J, these connection portions being formed as radial tracks 10AR, 10BR, 10CR, 10DR, 10ER, 10FR, 10GR, 10HR, 10IR, 10JR plated on the distal end face 12D of the core 12. Each connection portion extends from a distal end of the respective helical track to one of two arcuate tracks or conductors 10AE, 10FJ that are plated on the core distal face 12D adjacent the end of the bore and that form feed coupling nodes.

The two arcuate conductors 10AE, 10FJ are coupled, respectively, to the shield and inner conductors 16, 18 by conductors on a printed circuit board (PCB) assembly 19 comprising a laminate board secured to the core distal face 12D, as will described hereinafter. The coaxial transmission line feeder and the PCB assembly 19 together comprise a unitary feed structure before assembly into the core 12, and their interrelationship may be seen by comparing FIGS. 1 and 2.

Referring again to FIG. 2, the inner conductor 18 of the transmission line feeder has a proximal portion 18P which projects as a pin from the proximal face 12P of the core 12 for connection to the equipment circuitry. Similarly, integral lugs (not shown) on the proximal end of the shield 16 project beyond the core proximal face 12P for making a connection with the equipment circuitry ground.

The proximal ends of the antenna elements 10A-10J of the first set are interconnected by a conductive ring in the form of a narrow annular track located at an intermediate axial position on the cylindrical side surface portion of the core 12, between the elements 10A-10J of the first set and those 14A-14J of the second set. The helical antenna elements 10A-10J of the first set are uniformly spaced around the core 12 insofar as, at any given plane perpendicular to the core axis, they subtend substantially equal angles at the core axis. Each element is individually connected at a respective position to the distal edge 20D of the intermediate conductive ring 20.

The ten helical antenna elements 14A-14J of the second set are, likewise, uniformly distributed around the core. They have the same helical sense as the elements of the first set and they are individually connected to the proximal edge 20P of the intermediate conductive ring 20. Each of the helical elements 14A-14J of the second set executes a half-turn around the core and is individually connected to a common virtual ground conductor 21, which, in this embodiment, is annular, and in the form of a plated sleeve surrounding a proximal end portion of the core 12. This sleeve 21 is, in turn, connected to the shield conductor 16 of the feeder by a plated conductive covering 22 of the proximal end face 12P of the core 12.

The ten helical antenna elements 10A-10J of the first set constitute five pairs 10A, 10F; 10B, 10G; 10C, 10H; 10I; 10E, 10J of such elements, each pair having one helical element coupled to one of the arcuate conductors 10AE and another element coupled to the other of the arcuate conductors 10FJ and thence, respectively, to the inner conductor 18 and shield 16 of the transmission line feeder. In effect, therefore, the ten helical antenna elements 10A-10J may be regarded as being arranged in two groups of five 10A-10E; 10F-10J, all of the elements 10A-10E of one group being coupled to the first arcuate conductor 10AE and all of the elements 10F-10J of the other group being coupled to the second arcuate conductor 10FJ. Thus, the two arcuate conductors constitute first and second feed coupling nodes that interconnect the respective helical antenna elements, and provide common connections for the elements of each group to one or other of the conductors of the transmission line feeder via a matching network formed on the laminate board 19.

The ten helical antenna elements 10A-10J of the first set are of different lengths because, as can be seen in FIGS. 3A and 3B, the distal edge 20D of the intermediate conductive ring 20 is non-planar in order to assist in creating a phase progression in currents from element to element, thereby to promote a circular polarization at resonance.

Each track of one group of elements 10A-10E has a counterpart track located diametrically oppositely in the other group 10F-10J of helical elements. Each such pair of oppositely located tracks forms part of a respective conductive loop having an effective electrical length of about 360°, each loop running from one of the feed coupling nodes through, firstly, one helical track, via the distal edge or rim 20D of the intermediate conductive ring 20 and the other track, and thence to the other feed coupling node. Each such loop has a respective resonant frequency depending on its electrical length. Thus, the loops formed by the long tracks have resonant frequencies which are lower than the loops formed by the short tracks. The electrical phase progression from track to track of the helical elements 10A-10J of the first set is reinforced by the electrical length of the rim 20D of the ring 20 being 360° or a single guide wavelength at a first of two operating frequencies of the antenna. In this embodiment, this first resonant frequency is the higher of the two resonant frequencies and it is at this frequency that ring resonance is excited on the rim 20D. Since each conductive loop formed by the oppositely located pairs of tracks constituted by the helical elements 10A-10J of the first set, in conjunction with the associated radial conductors 10AR-10JR on the core distal face 12D, and together with the conductive ring 20, has an electrical length equivalent to about a full wavelength at the first operating frequency, a circular polarization resonance is created at the first operating frequency in a manner known in connection with other multifilar antennas as disclosed in the prior patent specifications mentioned above.

The helical elements 10A-10J of the first set, together with the intermediate conductive ring 20 form, effectively, part of the feed circuit for the helical elements 14A-14J of the second set. In the same way as described above in respect of the first set of helical elements, the helical elements 14A-14J of the second set may be regarded as five pairs of helical tracks, each track having a counterpart which, at any given axial position, is diametrically oppositely located on the outer surface of the core 12. Each track 14A-14J is connected to the rim 21U of the sleeve 21 so that each pair of oppositely located tracks forms a conductive loop having an electrical length of approximately 360° or a full wavelength at the second, lower operating frequency of the antenna, the lengths of the helical elements 14A-14J being adapted accordingly. The electrical length of the rim 21U is a full wavelength at the second operating frequency. Consequently, as a result of excitation by currents circulating on the intermediate conductive ring 20, a circular polarization resonance at the second operating frequency is produced, phasing of the currents in the individual helical elements 14A-14J being reinforced by the corresponding ring resonance of the rim 21U.

As has been stated above, each helical element 10A-10J, 14A-14J executes substantially a half turn of the core in this antenna, although alternative antennas may employ elements having other integer multiples (2, 3, 4, . . . ) of a half turn. The conductive sleeve 21, the plating 22 on the proximal end face 12P of the core, and the outer shield 16 of the feeder together form a quarterwave balun that provides common-mode isolation of the radiating antenna element structure from the equipment to which the antenna is connected when installed and when the antenna is operated at its operating frequencies. Currents in the sleeve are, therefore, confined to the sleeve rim 21U. Accordingly, at the operating frequency, the rim 21U of the sleeve 20 and the antenna element structure constituted by the helical elements form a network connected to a balanced feed.

As stated above, in this preferred embodiment of the invention, the circumferences of the edges 20D and 21U of the conducting ring 20 and the sleeve 21 are equal to the respective guide wavelengths at the first and second operating frequencies of the antenna. The above-described effect of reinforcing the resonant mode arising from the resonance of the helical element pairs is described in more detail in British Patent Application No. GB2346014A. The ring 20 and the sleeve 21 in each case acts as a resonant structure in itself, independently of the helical elements. Thus, the respective annular conductive path, having an electrical length equal to the operating wavelength, is resonant in a ring mode. Reinforcement of the resonant mode due to the pairs of helical elements and the annular path 20U can be visualised by imagining a wave being injected onto a ring at the junction of each of the helical elements and the relevant edge, the wave then travelling around the annular edge to form a spinning dipole, as described in GB2346014A. Owing to the electrical length of the annular edge, when the injected wave has travelled around the annular path and arrives back at the injection point, the next wave is injected from the respective helical element, thereby reinforcing the first. This constructive combination of waves results from the resonant length of the annular path.

Whilst the sleeve and plating of this embodiment of the invention are advantageous in that they provide both a balun function and a ring resonance, a ring resonance can also be provided independently by connecting the helical elements 14A-14J of the second set to an annular conductor that encircles the core 12 and has both proximal and distal edges on the outer side surface portion of the core, rather than being in the form of a sleeve connected to the feeder shield conductor 16 to form an open-ended cavity, as in the present embodiment. As in the case of the intermediate conductive ring 20, such a conductor may be comparatively narrow insofar as it may constitute an annular track the width of which is similar to the width of conductive tracks forming the helical elements 14A-14J and, providing it has an electrical length corresponding to the guide wavelength at the second operating frequency of the antenna, it still produces a ring resonance reinforcing the resonant mode associated with the loops provided by the helical elements 14A-14J and their interconnection.

The sleeve 21 and the plating 22 on the proximal end face 12P of the core together act as a trap preventing the flow of currents from the antenna elements 14A-14J to the shield conductor 16 at the proximal end face 12P of the core.

Operation of dielectrically loaded multifilar helical antennas having a balun sleeve is described in more detail in the above-mentioned British Patent Applications Nos. GB2292638A and GB2310543A.

The feeder transmission line performs functions other than simply as a line having a characteristic impedance of 50 ohms for conveying signals to or from the antenna element structure. Firstly, as described above, the shield 16 acts in combination with the sleeve 20 to provide common-mode isolation at the point of connection of the feed structure to the antenna element structure. The length of the shield conductor between (a) its connection with the plating 22 on the proximal end face 12P of the core and (b) its connection to conductors on the PCB assembly 19, together with the dimensions of the axial bore (in which the feeder transmission line is housed) and the dielectric constant of the material filling the space between the shield 16 and the wall of the bore, are such that the electrical length of the shield 16 on its outer surface is, at least approximately, a quarter wavelength at each of the frequencies of the two required modes of resonance of the antenna, so that the combination of the conductive sleeve 20, the plating 22 and the shield 16 promotes balanced currents at the connection of the feed structure to the antenna element structure.

In this preferred antenna, there is an insulative layer surrounding the shield 16 of the feed structure. This layer, which is of lower dielectric constant than the dielectric constant of the core 12, and is an air layer in the preferred antenna, diminishes the effect of the core 12 on the electrical length of the shield 16 and, therefore, on any longitudinal resonance associated with the outside of the shield 16. Since the modes of resonance associated with the required operating frequencies are characterised by voltage dipoles extending diametrically, i.e. transversely of the cylindrical core axis, the effect of the low dielectric constant sleeve on the required modes of resonance is relatively small due to the sleeve thickness being, at least in the preferred embodiment, considerably less than that of the core. It is, therefore, possible to cause the linear mode of resonance associated with the shield 16 to be de-coupled from the wanted modes of resonance.

The antenna has main resonant frequencies of greater than 500 MHz, the resonant frequencies being determined by the effective electrical lengths of the helical antenna elements 10A-10J, 14A-14J as described above. The lengths of the elements, for a given frequency of resonance, are also dependent on the relative dielectric constant of the core material, the dimensions of the antenna being substantially reduced with respect to an air-cored quadrifilar antenna.

The antenna is especially suitable for dual-band satellite communication at frequencies between 1 GHz and 3 GHz. In this case, the core 12 has a diameter of about 14 mm and the average axial length of the combination of the helical elements 10A-10D, 14A-14J of the two sets (i.e. parallel to the central axis) is about 29 mm. The length of the conductive sleeve 20 is typically in the region of 4 mm. Precise dimensions of the helical elements 10A to 10J, 14A-14J can be determined in the design stage on a trial and error basis by undertaking empirical optimisation until the required phase differences are obtained. They are typically about 1 mm in width, as is the intermediate conductive ring 20. The diameter of the coaxial transmission line in the axial bore of the core is in the region of 2 mm.

Further details of the feed structure will now be described. As shown in FIG. 2, the feed structure comprises the combination of a coaxial 50 ohm line 16, 17, 18 and the PCB assembly 19 connected to a distal end of the line. The laminate board constituting the PCB assembly 19 in this case is a planar multiple-layer printed circuit board that lies flat against the distal end face 12D of the core 12 in face-to-face contact. The largest dimension of the PCB assembly 19 is smaller than the diameter of the core 12 so that the PCB assembly 19 is fully within the periphery of the distal end face 12D of the core 12, as shown in FIG. 1.

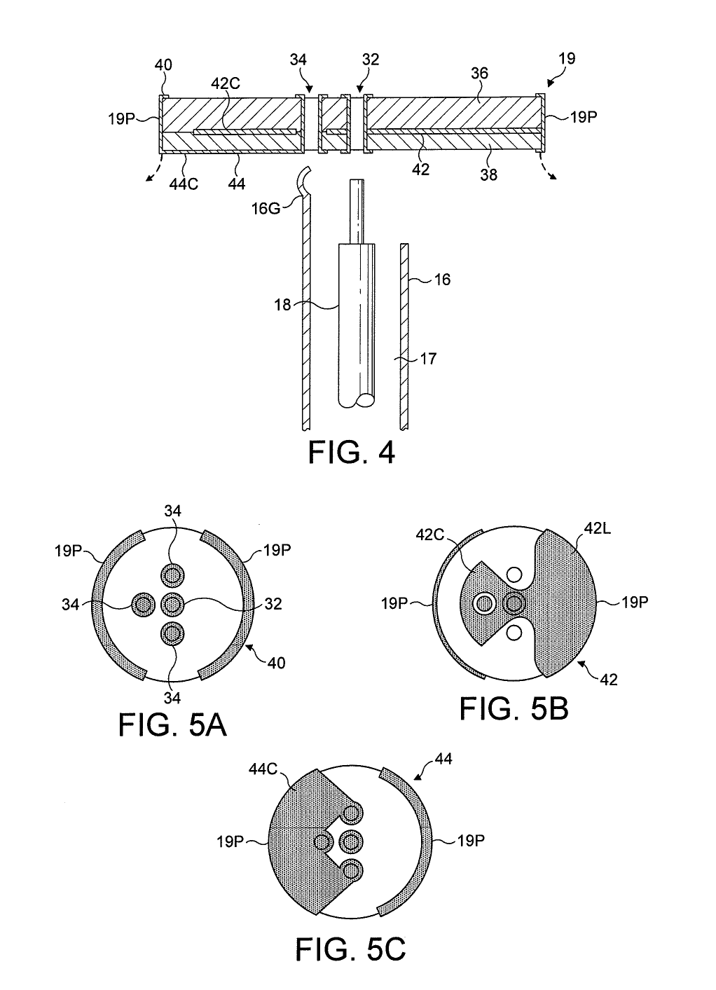

In this embodiment, the PCB assembly 19 is in the form of a disc centrally located on the distal face 12D of the core. Its diameter is such that it overlies the arcuate inter-element coupling conductors 10AE, 10FJ plated on the core distal face 12D. As shown in FIG. 4, the PCB assembly 19 has a substantially central hole 32 which receives the inner conductor 18 of the coaxial feeder transmission line. Three off-centre holes 34 receive distal lugs 16G of the shield 16. Lugs 16G are bent or “jogged” to assist in locating the assembly 19 with respect to the coaxial feeder structure. All four holes 32, 34 are plated through. In addition, portions 19P of the periphery of the PCB assembly 19 are plated, the plating extending onto the proximal and distal faces of the board.

The assembly 19 comprises a multiple-layer board in that it has a plurality of insulative layers and a plurality of conductive layers. In this embodiment, the board has two insulative layers comprising a distal layer 36 and a proximal layer 38. There are three conductor layers as follows: a distal layer 40, an intermediate layer 42, and a proximal layer 44. The intermediate conductor layer 42 is sandwiched between the distal and proximal insulative layers 36, 38, as shown in FIG. 4. Each conductor layer is etched with a respective conductor pattern, as shown in FIGS. 5A to 5C. Where the conductor pattern extends to the peripheral portions 19P of the PCB assembly 19 and to the plated-through holes 32, 34, the respective conductors in the different layers are interconnected by the edge plating and the hole plating respectively. As will be seen from the drawings showing the conductor patterns of the conductor layers 40, 42 and 44, the intermediate layer 42 has a first conductor area 42C in the shape of a fan or sector extending radially from a connection to the inner conductor 18 (when seated in hole 32) in the direction of the radial antenna element connection portions 10AR-10JR. Directly beneath this conductive area 42C, the proximal conductor layer 44 has a generally sector-shaped area 44C extending from a connection with the shield 16 of the feeder (when received in plated via 34) to the board periphery 19P overlying the arcuate or part-annular track 10AE interconnecting the radial connection elements 10AR-10ER. In this way, a shunt capacitor is formed between the inner feeder conductor 18 and the feeder shield 16, the material of the proximal insulative layer 38 acting as the capacitor dielectric. This material typically has a dielectric constant greater than 5.

The conductor pattern of the intermediate conductive layer 42 is such that it has a second conductor area 42L extending from the connection with the inner feeder conductor 18 to the second plated outer periphery 19P so as to overlie the arcuate or part-annular track 10FJ. There is no corresponding underlying conductive area in the conductor layer 44. The conductive area 42L between the central hole 32 and the plated peripheral portion 19P overlying the arcuate track 10FJ acts as a series inductance between the inner conductor 18 of the feeder and one of the groups of helical antenna elements 10F-10J.

When the combination of the PCB assembly 19 and the elongate feeder 16-18 is mounted to the core 12 with the proximal face of the PCB assembly 19 in contact with the distal face 12D of the core, aligned over the arcuate interconnection elements 10AE and 10FJ as described above, connections are made between the peripheral portions 19P and the underlying tracks on the core distal face 12D to form a reactive matching circuit having a shunt capacitance and a series inductance.

The proximal insulative layer of the PCB assembly 19 is formed of a ceramic-loaded plastics material to yield a relative dielectric constant for the layer 38 in the region of 10. The distal insulative layer 36 can be made of the same material or one having a lower dielectric constant, e.g. FR-4 epoxy board, which has a relative dielectric constant of about 4.5. The thickness of the proximal layer 38 is much less than that of the distal layer 36. Indeed, the distal layer 36 may act as a support for the proximal layer 38.

Connections between the feeder line 16-18, the PCB assembly 19 and the conductive tracks on the distal face 12D of the core are made by soldering or by bonding with conductive glue. The feeder 16-18 and the PCB assembly 19 together form a unitary feeder structure when the distal end of the inner conductor 18 is soldered in the via 32 of the PCB assembly 19, and the shield lugs 16G in the respective off-centre vias 34. The feeder 16-18 and the PCB assembly 19 together form a unitary feed structure with an integral matching network.

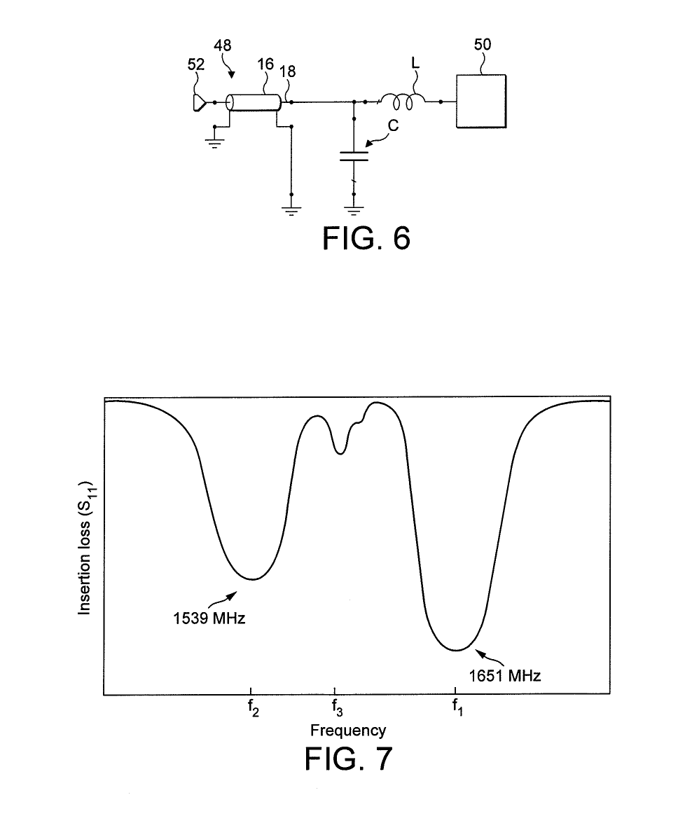

Referring to FIG. 6, the shunt capacitance and the series inductance, shown by C and L in this circuit diagram, form a matching network between the coaxial transmission line 48 at its distal end and the radiating antenna element structure, which appears in the circuit diagram as a sub-circuits 50. The shunt capacitance and the series inductance together match the impedance presented by the coaxial line, physically embodied as shield 16, insulative layer 17 and inner conductor 18, when connected at its proximal end to radiofrequency circuitry having a 50 ohm termination, this coaxial line impedance being matched to the impedance of the antenna element structure at its operating frequencies.

As stated above, the feed structure is assembled as a unit before being inserted in the antenna core 12, the laminate board of the PCB assembly 19 being fastened to the coaxial line 16-18. Forming the feed structure as a single component, including the assembly 19 as an integral part, substantially reduces the assembly cost of the antenna, in that introduction of the feed structure can be performed in two movements: (i) sliding the unitary feed structure into the axial bore of the core 12 and (ii) fitting a conductive ferrule or washer around the exposed proximal end portion of the shield 16. The ferrule may be a push fit on the shield component 16 or is crimped onto the shield. Prior to insertion of the feed structure in the core, solder paste is preferably applied to the connection portions of the antenna element structure on the distal end face 12D of the core 12 and on the plating 22 immediately adjacent the respective ends of the axial bore. Therefore, after completion of steps (i) and (ii) above, the assembly can be passed through a solder reflow oven or can be subjected to alternative soldering processes such as laser soldering, inductive soldering or hot air soldering as a single soldering step.

Solder bridges formed between (a) conductors on the peripheral and the proximal surfaces of the laminate board of the PCB assembly 19 and (b) the metallised conductors on the distal face 12D of the core, and the shapes of the conductors themselves, are configured to provide balancing rotational meniscus forces during reflow soldering when the board is correctly orientated on the core.

Using the structure described above, it is possible to create a dual-band circularly polarized frequency response, as shown by the insertion loss graph of FIG. 7. The antenna has a first circular polarization resonance at an upper resonant upper frequency f₁ and a second circular polarization resonance at a lower resonant frequency f₂. There is also, in this embodiment, a resonance at an intermediate frequency f₃, but this is a non-radiating resonance. In this embodiment of the invention, f₁ is about 1651 MHz and f₂ is about 1539 MHz, these being the centre frequencies of the two bands of the Inmarsat (Registered Trade Mark) satellite telephone service. In this case, the frequency separation f₂−f₁ of the two centre frequencies is about 7 percent of the mean frequency. In the antenna described and shown above, the antenna has a predominantly upwardly directed radiation pattern in respect of right-hand circularly polarized waves.

In other embodiments, suitable for different satellite communication or navigation services, the lengths of the helical elements and the circumferences of the intermediate conductive ring and the balun sleeve are altered. Other variables include the degree to which the edges of the conductive ring and the balun sleeve deviate from a planar profile. It is also possible to vary the relative dielectric constant of the core material as well as the size of the core itself.

In general, the invention is suitable for frequency separations (with respect to the mean of the respective operating frequencies) of between 3 percent and 20 percent, with particular utility above 5 percent. The main advantage over the structure shown in the applicant's GB 2468582A is that separation of the helical elements into two sets with respective annular conductive paths interconnecting the helical elements 10A-10J, 14A-14J in each case allows ring resonances of different frequencies to be provided (corresponding to the ring resonant frequencies of the intermediate conductive ring 20 and the sleeve 21 respectively). In general, owing to the lesser degree to which the electric field associated with circulating currents in the intermediate conductive ring 20 is confined within the dielectric material of the core, the ring resonance of the intermediate conductive ring is higher than that provided by the rim of the sleeve 21. It is for this reason that the preferred antenna exhibits a higher resonant frequency associated with the first set of helical elements 10A-10J, compared with that of the second set 14A-14J.

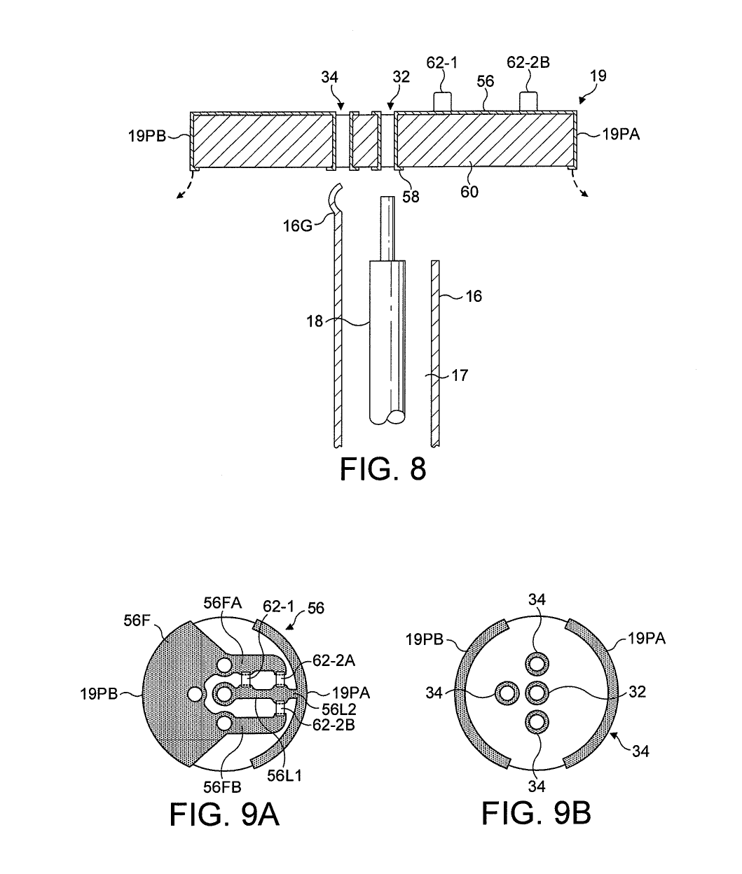

When the match loci of the unmatched nodes of resonance are insufficiently close together on an impedance Smith chart, a two-pole matching network is preferred. Referring to FIGS. 8, 9A, 9B and 10, an alternative feed structure has a PCB assembly 19 in the form of a double-sided printed circuit board that, as in the previous embodiment, lies flat against the distal end face 12D of the core in face-to-face contact. As before, the printed circuit board has a substantially central hole 32 which receives the inner conductor of the coaxial feeder transmission line, and three off-centre holes 34 receive distal lugs 16G of the shield 16. As before, all four holes 32, 34 are plated through and, in addition, peripheral portions 19PA, 19PB of the board periphery are plated, the plating extending onto both proximal and distal faces of the board.

This alternative PCB assembly 19 has a double-sided laminate board in that it has a single insulative layer and two patterned conductive layers. Additional insulative and conductive layers may be used in alternative embodiments of the invention. As shown in FIG. 8, in this embodiment, the two conductive layers comprise a distal layer 56 and a proximal layer 58 which are separated by the insulative layer 60. This insulative layer 60 is made of FR-4 glass-reinforced epoxy board. The distal and proximal conductor layers are each etched with a respective conductor pattern, as shown in FIGS. 9A and 9B respectively. Where the conductor pattern extends to the peripheral portions 19PA, 19PB of the laminate board and to the plated-through holes 32, 34, the respective conductors in the different layers are interconnected by the edge plating and the hole plating respectively. As will be seen from the drawings showing the conductor patterns of the conductor layers 56, 58, the distal conductive layer 56 has an elongate conductor track 56L1, 56L2 that connects the inner feed line conductor 18, when it is housed in the central hole 32 in the laminate board, to a first peripheral plated edge portion 19PA of the board. This elongate track is in two parts 56L1, 56L2 which, owing to their relatively narrow elongate shape constitute inductances at frequencies in operation of the antenna. Since the edge portion 19PA is connected via one 10FJ of the arcuate tracks to half of the radial conductors 10FR-10JR on the distal end face 12D of the core (FIG. 1), these inductances are in series between (i) the inner feed line conductor 18 and (ii) five of the helical elements 10F-10J of the first set. If, in the space available on the laminate board, a single track portion 56L1, 56L2 of sufficient length to yield a required inductance cannot be accommodated, either track portion 56L1, 56L2 can be divided into two parallel track portions, i.e. with a slit between them, to produce a greater inductance per unit length.

The feed line shield 16, when housed in the holes 34 in the laminate board, is connected directly to the opposite peripheral plated edge portion 19PB of the board by a fan-shaped conductor 56F which, owing to its relatively large area, has low inductance. Accordingly, the shield is connected directly to the other antenna elements 10A-10E of the first set via the other arcuate track 10AE and the respective radial conductors 10AR-10ER (FIG. 1).

The fan-shaped conductor 56F is extended towards the first peripheral plated edge portion 19PA alongside the inductive elongate track 56L1, 56L2, to provide pads for discrete shunt capacitances. Accordingly, in this embodiment, the fan-shaped conductor 56F has two extensions 56FA, 56FB running parallel to the inductive track 56L1, 56L2 on opposite sides thereof. Each extension 56FA, 56FB is formed as a track that is much wider and, therefore, of negligible inductance, compared to the central inductive track. One of these extensions 56FA provides pads for a first chip capacitor 62-1 connected to the plating associated with the central hole 32 and a second chip capacitor 62-2A connected to the junction between the two inductive track parts 56L1, 56L2. The other extension 56FB provides a pad for a third chip capacitor 62-2B which is also connected to the junction between inductive track parts 56L1, 56L2. In this embodiment of the invention, the capacitors 62-1, 62-2A, 62-2B are 0201 size chip capacitors (e.g. Murata GJM).

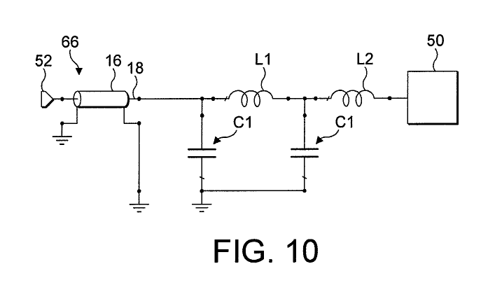

The above-described combination constitutes a two-pole reactive matching network shown schematically in FIG. 10. The network provides a dual-band match between (a) the distal and proximal parts respectively of the radiating element structure and associated parts and (b) a 50 ohm load 52. In this example, the feed line 16-18 (FIG. 8) is a 50 ohm coaxial line section 66 Inductors L1 and L2 are formed by the track sections 56L1, 56L2 referred to above. The shunt capacitance C1 is that indicated as capacitor 62-1 in FIGS. 8 and 9A. The other shunt capacitance C2 is formed by the parallel combination of the two chip capacitors 62-2A, 62-2B described above with reference to FIG. 9A. Using two capacitors for the second capacitance C2 allows a relatively high capacitance value to be obtained using low profile chip capacitors and reduces resistive losses.

The network constituted by the series inductances L1, L2 and the shunt capacitances C1, C2 form a matching network between the radiating antenna element structure of the antenna and a 50 ohm termination at the proximal end of the transmission line section when connected to radio frequency circuitry, this 50 ohm load impedance being matched to the impedance of the antenna element structure at its operating frequencies.

In the antenna described above, the helical elements of the second set are of the same helical sense as the elements of the first set. In an alternative embodiment of the invention, the first and second sets of elements may have opposite senses. Thus, for instance, the first set may have elements with a right-hand screw sense and those of the second set a left-hand screw sense, or vice-versa. Such an embodiment is applicable to use with transmissions of opposite polarizations.

What is claimed is:

1. A dielectrically loaded antenna for operation at first and second frequencies above 200 MHz and with circularly polarized radiation, wherein the antenna comprises:
an electrically insulative dielectric core of a solid material which has a relative dielectric constant greater than 5, the core having an outer surface with a side surface portion and proximal and distal end surface portions, and the material of the core occupying the major part of the interior volume defined by the core outer surface;
a pair of feed coupling nodes; and
a three-dimensional antenna element structure linked to the feed coupling nodes and including a plurality of elongate conductive antenna elements distributed around the core on or adjacent the said side surface portion;
wherein the antenna element structure is divided into a distal section and a proximal section respectively comprising a first set of elongate conductors on or adjacent a distal part of the core side surface portion and a second set of elongate conductors on or adjacent a proximal part of the core side surface portion, and wherein the first set of conductors is resonant at the first operating frequency and the second set of conductors is resonant at the second operating frequency.

2. An antenna according to claim 1, wherein the antenna element structure further comprises an intermediate conductive ring encircling the core and located between the first set of elongate conductors and the second set of elongate conductors, one of the said sets of elongate conductors linking the feed nodes and the intermediate ring.

3. An antenna according to claim 2, further comprising a matching network between the feed nodes and the said one set of elongate conductors.

4. An antenna according to claim 2, wherein the elongate conductors of the other set are connected individually to the intermediate ring.

5. An antenna according to claim 2, wherein the feed coupling nodes are located at one of the said end surface portions of the core, and wherein the antenna further comprises a second conductive ring located in the region of the other of said core end surface portions, the elongate conductors of the said other set extending from the intermediate ring to the second ring.

6. An antenna according to claim 5, wherein the second conductive ring is in the form of a balun sleeve.

7. An antenna according to claim 5, wherein the second conductive ring defines an annular conductive path of an electrical length of one wavelength at the resonant frequency of the said other set of elongate conductors.

8. An antenna according to claim 2, wherein the intermediate conductive ring defines an annular conductive path of an electrical length of one wavelength at the resonant frequency of the said one set of elongate conductors.

9. An antenna according to claim 1, wherein the core has a substantially constant cross-section between the proximal and distal end surface portions.

10. An antenna according to claim 9, wherein the core is cylindrical and the elongate conductors of the first set and those of the second set are helical.

11. An antenna according to claim 1, in the form of a backfire antenna having a feed structure including a transmission line section extending through the core from feed coupling nodes at the said distal end surface portion to terminations in the region of the proximal end surface portion.

12. An antenna according to claim 2, wherein the resonant frequency of the said one set of the elongate conductors is higher than the resonant frequency of the other set of elongate conductors.

13. An antenna according to claim 1, wherein the frequency spacing of the first and second operating frequencies is in the range from three percent to 50 percent of the average of the first and second operating frequencies.

14. An antenna according to claim 1, wherein:
the core is cylindrical and feed coupling nodes are associated with one of the said end surface portions;
the antenna element structure includes an intermediate conductive ring encircling the core at a position between the end surface portions and a second conductive ring located on the opposite side of the intermediate ring from the feed coupling nodes;
the first set of elongate conductors comprises a first set of helical radiating elements forming part of a conductive structure linking the feed coupling nodes to one edge of the intermediate ring, which edge has a ring resonance at one of the said operating frequencies; and
the second set of elongate conductors comprises a second set of helical radiating elements forming part of or constituting a conductive structure linking the outer edge of the intermediate ring to an edge of the second conductive ring, which edge was a ring resonance at the other of the said operating frequencies.

15. An antenna according to claim 14, wherein the feed coupling nodes are associated with the distal end surface portion of the core and the antenna further comprises an axial transmission line section extending through the core from the proximal end surface portion to the feed coupling nodes, and wherein the second conductive ring forms part of a balun conductor extending over the proximal core end surface portion to a connection with the transmission line section.
